(19) United States
(12) Patent Application Publication
(10) Pub. No.: US 2022/0293004 A1
(43) Pub. Date: Sep. 15, 2022

(54) INTERACTIVE LEARNING

(71) Applicant: Moonshot Sports LLC, Holladay, UT (US)

(72) Inventors: Whitney Clayton, Holladay, UT (US); Matthew Clayton, Provo, UT (US)

(21) Appl. No.: 17/691,076

(22) Filed: Mar. 9, 2022

Related U.S. Application Data
(60) Provisional application No. 63/158,795, filed on Mar. 9, 2021.

(51) Int. Cl. G09B 19/00; G09B 7/00

(52) U.S. Cl. CPC G09B 19/0038; G09B 7/00; G09B 7/02

(57) ABSTRACT

Apparatuses, methods, program products, and systems are disclosed for interactive learning. An apparatus includes a content module that receives content for generating at least one learning games for a subject. An apparatus includes a gamification module that generates the at least one learning game based on the received content. An apparatus includes a competition module that creates at least one competition using the at least one learning game between a plurality of users associated with the subject.

### CROSS-REFERENCES TO RELATED APPLICATIONS

This application claims the benefit of U.S. Provisional Patent Application No. 63/158,795 entitled “INTERACTIVE TRAINING AND COACHING MANAGEMENT” and filed on Mar. 9, 2021, for Whitney Clayton, et al., which is incorporated herein by reference

### FIELD

This invention relates to training and more particularly relates to interactive learning.

### BACKGROUND

Different learning strategies have been devised to learn a subject; however, some learning strategies may be tedious and time consuming to establish.

### SUMMARY

An apparatus for interactive learning is disclosed. A system, method, and program product also perform the functions of the apparatus.

In one embodiment, an apparatus includes a content module that receives content for generating at least one learning games for a subject. In one embodiment, an apparatus includes a gamification module that generates the at least one learning game based on the received content. In one embodiment, an apparatus includes a competition module that creates at least one competition using the at least one learning game between a plurality of users associated with the subject.

In one embodiment, an apparatus includes a playbook module that generates a digital playbook comprising a plurality of plays for a sporting team, the received content comprising the plurality of plays.

In one embodiment, the playbook module presents an interface for generating a play for the digital playbook.

In one embodiment, the playbook module presents one or more predesigned plays that can be selected to add to the digital playbook.

In one embodiment, the at least one learning game comprises questions related to at least one play within the digital playbook.

In one embodiment, an apparatus includes a multimedia module that receives and integrates multimedia content into at least one of the digital playbook and the at least one learning game.

In one embodiment, an apparatus includes an integration module that communicates with at least one third-party application for receiving at least one of the digital playbook and the multimedia content.

In one embodiment, the playbook module generates metadata tags for the multimedia content based on one or more identifiable characteristics of the multimedia content, the metadata tags used to generate the at least one learning game.

In one embodiment, an apparatus includes a dashboard module that provides an interface for visualizing statistics generated as a result of the at least one competition.

In one embodiment, the at least one competition comprises a real-time competition between the plurality of users.

In one embodiment, an apparatus includes an environment module that renders the at least one learning game in one of a virtual reality and augmented reality environment.

In one embodiment, the received content comprises a plurality of flash cards associated with the subject.

In one embodiment, a method includes receiving, by a processor, content for generating at least one learning games for a subject, generating at least one learning game based on the received content, and creating at least one competition using the at least one learning game between a plurality of users associated with the subject.

In one embodiment, the method includes generating a digital playbook comprising a plurality of plays for a sporting team, the received content comprising the plurality of plays.

In one embodiment, the method includes presenting an interface for generating a play for the digital playbook.

In one embodiment, the method includes presenting one or more predesigned plays that can be selected to add to the digital playbook.

In one embodiment, the method includes providing an interface for visualizing statistics generated as a result of the at least one competition.

In one embodiment, the method includes rendering the at least one learning game in one of a virtual reality and augmented reality environment.

In one embodiment, the received content comprises a plurality of flash cards associated with the subject.

In one embodiment, an apparatus includes means for receiving content for generating at least one learning games for a subject, means for generating at least one learning game based on the received content, and means for creating at least one competition using the at least one learning game between a plurality of users associated with the subject.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for interactive learning;

FIG. 2 is a schematic block diagram illustrating one embodiment of an apparatus for interactive learning;

FIG. 3 is a schematic block diagram illustrating one embodiment of an apparatus for interactive learning;

FIG. 4 is a schematic block diagram illustrating one embodiment of a method for interactive learning;

FIG. 5A is one embodiment of a quiz interface for interactive learning;

FIG. 5B is another embodiment of a quiz interface for interactive learning;

FIG. 5C is yet another embodiment of a quiz interface for interactive learning;

FIG. 6A is one embodiment of a lesson interface for interactive learning;

FIG. 6B is another embodiment of a lesson interface for interactive learning;

FIG. 6C is yet another embodiment of a lesson interface for interactive learning;

FIG. 7A is one embodiment of a media gallery interface for interactive learning;

FIG. 7B is one embodiment of a content annotation interface for interactive learning;

FIG. 8A is one embodiment of a game interface for interactive learning;

FIG. 8B is another embodiment of a game interface for interactive learning;

FIG. 9A is one embodiment of a dashboard interface for interactive learning;

FIG. 9B is another embodiment of a dashboard interface for interactive learning; and

FIG. 10 is one embodiment of a multi-player game interface for interactive learning.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

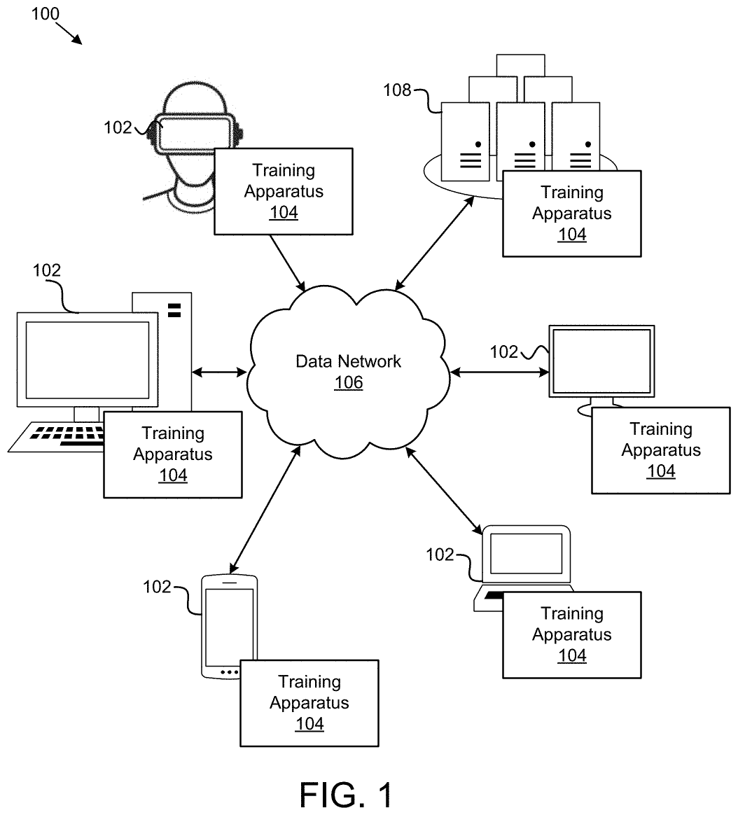

FIG. 1 is a schematic block diagram illustrating one embodiment of a system 100 for dynamic client/server selection for interactive learning execution. In one embodiment, the system 100 includes one or more information handling devices 102, one or more training apparatuses 104, one or more data networks 106, and one or more servers 108. In certain embodiments, even though a specific number of information handling devices 102, training apparatuses 104, data networks 106, and servers 108 are depicted in FIG. 1, one of skill in the art will recognize, in light of this disclosure, that any number of information handling devices 102, training apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

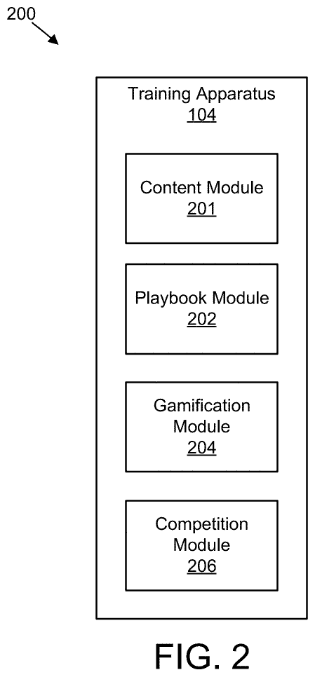

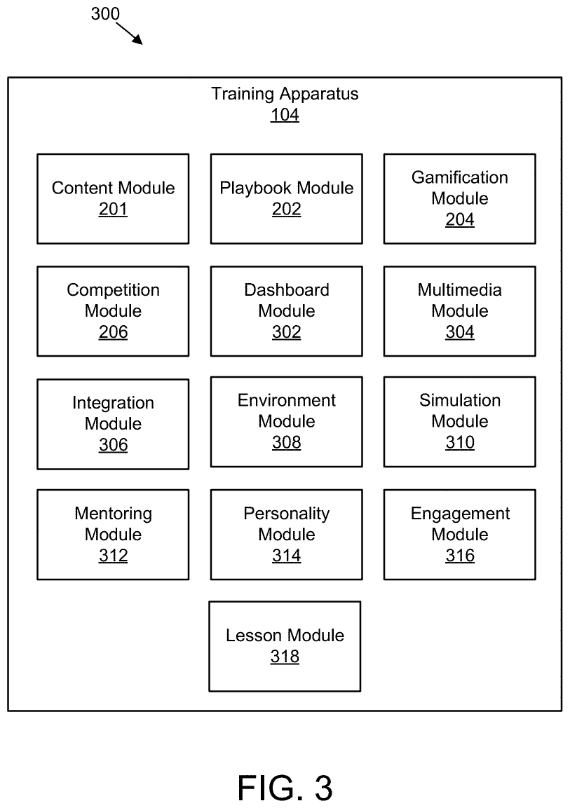

In general, in one embodiment, the training apparatus 104 is configured to generate a digital playbook comprising a plurality of plays for a sporting team, generate at least one learning game based on the digital playbook, and create at least one competition using the at least one learning game between a plurality of members of the sporting team. In this manner, as described in more detail below, the training apparatus 104 provides a platform for team members to learn plays, strategies, and collaborate in a competitive environment by playing games that are automatically generated based on the team's own playbook. The training apparatus 104 is described in more detail below with reference to FIGS. 2 and 3.

In certain embodiments, the training apparatus 104 may include a hardware device such as a secure hardware dongle or other hardware appliance device (e.g., a set-top box, a network appliance, or the like) that attaches to a device such as a head mounted display, e.g., a virtual reality headset such as an Oculus®, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the training apparatus 104 may include a power interface, a wired and/or wireless network interface, a graphical interface that attaches to a display, and/or a semiconductor integrated circuit device as described below, configured to perform the functions described herein with regard to the training apparatus 104.

The training apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the training apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the training apparatus 104.

The semiconductor integrated circuit device or other hardware appliance of the training apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the training apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may be configured to store, host, upload, download, and/or the like multimedia content; execute machine learning/artificial learning algorithms; and/or the like.

FIG. 2 depicts one embodiment of an apparatus 200 for interactive learning. The apparatus 200, in one embodiment, includes an instance of a training apparatus 104. The training apparatus 104, in one embodiment, includes one or more of a content module 201, a playbook module 202, a gamification module 204, and a competition module 206, which are described in more detail below.

In one embodiment, the content module 201 is configured to receive, generate, capture, download, access, and/or the like content for generating one or more learning games. In one embodiment, the content may include material related to a subject such as a sport, a school subject (e.g., biology, physics, math, or the like), a vocation, a job, a hobby, and/or the like. In one embodiment, the content may include digital flash cards, slides, videos, audio files, images, files, documents, and/or the like. Even though the proposed solutions described below are explained using sports as an example, one of skill in the art will recognize that the subject matter herein is applicable to various types of subjects.

In one embodiment, the content may be a playbook for learning various characteristics of a sport. In such an embodiment, the playbook module 202 is configured to generate a digital playbook comprising a plurality of plays for a sporting team. As used herein, a playbook may refer to a “book,” e.g., a collection of a sports team's strategies and plays for a sporting team such as American football (hereinafter “football”), basketball, soccer, hockey, and/or the like. A play, as used herein, may refer to a designed strategy for achieving a desired result during gameplay. For example, in football a play may be an offensive “plan of action” or “strategy” used to move the ball down the field and/or a defensive action to prevent an offense from moving the ball down the field.

A play may comprise a diagram, schematic, or other graphical representation of the play that includes symbols, icons, graphics, or the like to represent players (offensive and/or defensive), directions, movements, positions, and/or the like. A play may also be explained using a textual description, a series of steps, and/or the like, and may be modeled using a markup language such as XML.

In on embodiment, the playbook module 202 may present an interface for generating a play for the digital playbook. The interface may be an interactive graphical user interface that comprises graphical elements representing different characteristics of a play. For example, the interface may include symbols, icons, or the like that represent players, direction of movement, the field of play and markers on the field of play (e.g., yard lines), and/or the like. The interface may be interactive in that the user can drag and drop icons onto the interface, move or reposition icons, draw on the play (e.g., draw lines for showing where a player should move), and/or the like. When done, the user may save, commit, store, or the like the play to the digital playbook.

In further embodiments, the playbook module 202 may present one or more predesigned or predefined plays for the user to select to add to the digital playbook. The predesigned plays may be plays that the user has previously created, plays that other user have generated, plays for other teams such as club, college, or professional teams, and/or the like.

The playbook module 202, in one embodiment, may receive uploads of plays as images, documents, film clips, and/or the like formats, which the playbook module 202 may convert to a digital version of the play using optical character recognition (“OCR”), image processing, and/or the like. For instance, the playbook module 202 may convert an uploaded drawing of a play to a digital or computer format that includes graphical user interface elements, vector graphics, and/or the like to represent the different parts of the play, e.g., the players, directions, movements, ball, or the like.

The playbook module 202, in some embodiments, communicates or interfaces with third-party playbook applications, e.g., Hudl®, Playmaker Pro, or the like, using an interface such as an application programming interface (“API”), a command line interface (“CLI”), and/or the like to receive a previously created digital playbook for a team. The playbook module 202 may receive and/or store the user's electronic credentials for the third-party application, e.g., a username/password, a PIN, a passphrase, a biometric credential, and/or the like for accessing the user's content on the third-party application. In some embodiments, the playbook module 202 scrapes online sources, e.g., webpages, for playbooks/plays.

The playbook module 202 may map the graphical representations of the components of the diagrammed play that the third-party application uses to the same or different graphical representations that the playbook module 202 uses to represent the components of the diagrammed play, e.g., using vector graphics. In one embodiment, the playbook module 202 provides a graphical play editor that a user interacts with to diagram plays.

The playbook module 202, in one embodiment, also imports or receives information regarding a team, player personnel, and/or the like related to the playbook. For instance, the playbook module 202 may receive (e.g., via an upload or API) roster information, team strategies, quiz/lesson material, slides, film, and/or the like, which the playbook module 202 may process, analyze, and/or the like to incorporate team information into the playbook and learning games, as described below.

The gamification module 204, in one embodiment, is configured to generate at least one learning game based on the content that the content module 202 receives, generates, captures, downloads, accesses, and/or the like, e.g., flash cards or a digital playbook. The learning game may include a quiz, test, poll, and/or the like that includes a series of questions about the content, e.g., about the digital playbook in general, about a particular play, about a particular player in the play, and/or the like.

For example, the gamification module 204 may process the text, images, or the like of a series of flash cards from the content module 202 and generate multiple-choice questions, fill in the blank questions, free form questions, and/or the like for a quiz, test, and/or other learning game.

In another example, the gamification module 204 may present a diagram of the play and prompt the user to identify the name of the play from a list of possible names, e.g., a multiple-choice question and/or to manually enter the name of the play as a free form question. In yet another example, the gamification module 204 may present a diagram of a play that shows various directions that a particular player can go (e.g., different passing routes for a wide receiver), and prompt the user to select the correct path for the particular play.

In one example, the gamification module 204 may present a diagram of an offensive play and a defensive front against the offensive play. The gamification module 204 may prompt the user to identify the correct play to make (e.g., the correct pass to make, the correct shot to take, or the like), may prompt the user to select an alternative play, e.g., an audible, based on the defensive front, and/or the like. In certain embodiments, the learning games may be timed, e.g., two minutes to answer ten questions, and/or the like. The gamification module 204 may further provides rewards, virtual currency, points, rankings, and/or the like for answering questions correctly, which may be redeemed. The gamification module 204 may provide an interface for a user such as a coach to access to create their own games, questions, and/or the like.

In one embodiment, the gamification module 204 sequences learning games to include a spectrum from theoretical knowledge to applied knowledge. For instance, users may learn theoretical concepts, e.g., theoretical football or basketball strategy in general, for a particular position, or the like, through a series of learning games and then simulate application of the theoretical concepts using 3D, virtual reality, and/or augmented reality experiences. Similarly, concepts that are based on the digital playbook may be presented as learning games within a 3D, virtual reality, and/or augmented reality interface.

In certain embodiments, the gamification module 204 may present the sequence of learning games in order of difficulty level. For instance, a quiz may include a series of questions of varying difficulty. The gamification module 204 may present a baseline question and the user's response (correct or incorrect) may determine the difficulty of the following question that is presented to the user, and so on.

In one embodiment, each player's progress through the learning games becomes increasingly personalized based on the player's stats, previous learning game results, the player's position, the player's learning style, the priority of the content, the player's motivational style, and/or the like. In one embodiment, the gamification module 204 may utilize machine learning/artificial intelligence to personalize the learning games, questions, and/or other content, and adapt the learning games to the user's skill level, learning style, and/or the like. In such an embodiment, the gamification module may train a machine learning model based on training data such as the user's previous responses to questions, which is then used to personalize the learning games presented to the user.

Regarding learning styles, in one embodiment, the gamification module 204 builds learning experiences and games that facilitate optimal learning tailored to different learning inclinations including visual (e.g., players learning through incorporating video playback of themselves and others); spatial (e.g., players learn through diagrams and charts); verbal (e.g., players learn through written and spoken language); and kinesthetic (e.g., players learn through body movements; the gamification module 204 may present instructions, guides, or the like for directing the players movements and may track or monitor the movements using sensors in a device such as a phone or VR headset and other equipment such as hand devices, haptic suits, or the like; in this manner, the gamification module 204 can train the physical muscle reaction of a player for how to response in various sports situations).

In one embodiment, the gamification module 204 automatically generates learning games, e.g., quizzes, based on the content that has been generated or uploaded, e.g., flash cards, plays in the digital playbook, lessons, slides, game film, pictures, videos, and/or the like. In certain embodiments, the gamification module 204 presents an interface for a user to “hand build” learning games, e.g., manually entering a question and a series of possible answers for a quiz question, selecting a video and entering a question and possible answers related to the video, and/or the like.

In one embodiment, the competition module 206 is configured to create at least one competition using the at least one learning game between a plurality of members of the sporting team. For example, the offensive players on a football team may compete to determine who knows the plays the best by answering a series of questions related to the offensive playbook within a predetermined period of time. Similarly, players on a basketball team may compete to determine who knows the offensive plays to run against man defense versus against zone defense. In another example, students in a math class may compete to determine who can solve a series of math questions the fastest.

The competition module 206 may provide live, real-time competitions and/or offline competitions. For instance, a coach may create a pop quiz, e.g., on this week's opponent, and send it to all of the players on the team, a subset of the players on the team (e.g., a particular unit such as the offensive line, the kickoff team, the running backs, the defensive backs, and/or the like), a single player on the team, the coaching staff, and/or the like that has to be completed in real-time, within an hour, and/or the like. Similarly, a teacher may create a physics quiz on a recently discussed topic for his/her students to complete within a period of time.

The competition module 206 may send a notice or link to the competition via a text message, a push notification, a social media notification, an email, a phone message, and/or the like. Other notifications may be sent when new content is added/created, when competitions have completed, when the leaderboard has changed, and/or the like. In certain embodiments, the competition module 206 may provide a chat feature during a competition for members of the team to user to chat or “trash talk” each other during the competition.

In one embodiment, the playbook module 202 downloads college playbooks, semi-pro playbooks, professional teams' playbooks, and/or the like and the gamification module 204 generates learning games for the playbooks to further increase a player's knowledge, team IQ, and/or the like. The playbook module 202 may integrate college and professional plays, schemes, and/or the like into the team's playbook from the built-in library of college and professional plays.

FIG. 3 depicts one embodiment of an apparatus 300 for interactive learning. The apparatus 300, in one embodiment, includes an instance of a training apparatus 104. The training apparatus 104, in one embodiment, includes one or more of a playbook module 202, a gamification module 204, and a competition module 206, which may be substantially similar to the playbook module 202, the gamification module 204, and the competition module 206 described above. In further embodiments, the training apparatus 104 includes an instance of a dashboard module 302, a multimedia module 304, an integration module 306, an environment module 308, a simulation module 310, a mentoring module 312, a personality module 314, an engagement module 316, and a lesson module 318, which are described in more detail below.

In one embodiment, the dashboard module 302 is configured to provide an interface for visualizing statistics generated as a result of the at least one competition. For example, a coach or teacher may login to his/her account and see the results, statistics, trends, and/or the like of the competitions for the team overall, for the coaching staff, for certain playing units (e.g., offense, defense, special teams, linemen, linebackers, defensive backs, quarterbacks, running backs, wide receivers, guards, forwards, centers, and/or the like).

For example, the dashboard module 302 may display an individual player's mastery of the playbook, the whole team's mastery, each unit's mastery (percentage shown by play and/or over time), playbook master by scheme (percentage shown by individual player, whole team, units, and/or the like), opponent preparation (e.g., mastery of an opponent's playbook), and/or the like, which may be based on a matrix database generated by results from the games played. The dashboard module 302 may also provide a leaderboard for players for the entire team, for units of the team, and/or the like. Further, as explained in more detail below, the dashboard module 302 may present the user's wellness data including personality assessment results, academic performance (e.g., grades), and/or the like.

The multimedia module 304, in one embodiment, is configured to receive/access, and integrate multimedia content into the digital playbook, a learning game, a competition, and/or the like. For instance, the multimedia module 304 may present images or videos of actual, real life game play from a previous game that the team played, from a game played by another team, from a professional or semi-professional team, and/or the like and then present questions about the images or videos.

For instance, the multimedia module 304 may incorporate a team's game film from a previous game into a quiz or test to see if the players in the film know whether they were in the correct positions or not, what certain players could have done better or differently, and/or the like. The multimedia module 304, in some embodiments, may show a video, an animation, a breakdown, a diagram, and/or the like of how the play should be run/executed after a question about the play is presented/answered.

In one embodiment, the playbook module 202 and/or the multimedia module 304 matches each play in the playbook with video from the team's game film or other video library so that users can see a play in live action, against different defenses, and/or in other situations. In such an embodiment, the playbook module 202 and/or the multimedia module 304 automatically tags the game film or other video using various metadata tags such as offense/defense, play type (e.g., run or pass), personnel within the film, weather, location, time of day, and/or the like. In such an embodiment, the playbook module 202 may process the video frame by frame, or by a group of frames, to identify characteristics of the video (listed above).

In some embodiments, the playbook module 202 and/or the multimedia module 304 converts the team's game film into learning games, e.g., “what is this formation?”, “what coverage is the defense in?”, “what is the pre-snap read?”, “where should the receiver run on this play?”, “where should the screen be set on this play?”, and/or the like. In one embodiment, the multimedia module 304 may download college and professional game film and associate the film with the corresponding college and professional plays, which can be used to create learning games and competitions for the college and professional playbooks.

In some embodiments, the playbook module 202 and/or the multimedia module 304 provides tools for annotating film clips, game film, pictures, slides, and/or the like. The annotations may include drawing tools, e.g., freehand, lines, squares, circles, arrows, or the like; audio annotations; film annotations; hyperlinks; and/or the like. The annotations may be shared with all users, with certain groups of users, e.g., offensive players, coaches, or the like, and/or the like.

In certain embodiments, the integration module 306 is configured to communicate with at least one third-party application for receiving the digital playbook, multimedia content, and/or the like. For example, the integration module 306 may interface with Hudl® to access, download, pull, or the like a team's game film, an opposing team's scout film, practice film, a team's playbook created in Hudl®, and/or the like.

Similarly, the integration module 306 may interface with a social media network, e.g., a team's Instagram® page, a photo or video sharing site (e.g., YouTube®), or the like, to access or download images, videos, and/or the like, which can be used to create learning games or lessons.

The environment module 308, in one embodiment, is configured to render learning games within a virtual reality and/or augmented reality environment. For instance, the environment module 308 may render virtual or augmented reality graphics representing different components of a play such as a player, a direction that a player should go, the ball, opponent players, and/or the like that a user can interact with using virtual/augmented reality headsets and controls.

In such an embodiment, the environment module 308 may use the content that is generated, uploaded, and/or received, such as playbook information, game film, pictures, or the like, to automatically generate a 3D or virtual experience for the user, which may be viewed on a device such as a phone, tablet, headset, and/or the like.

In one embodiment, the environment module 308 uses playbook diagrams to generate dynamic/moving images that reflect player movement within a game using an understanding of how player movement happens in a given sport, interactions between multiple players in that sport, and biometric data for each player.

In one embodiment, the playbook becomes dynamic or multi-step. For instance, player motion in a sport is sequential and reactive to multiple variables, rather than each player moving on a fixed path. Accordingly, the environment module 308 allows users to provide “if/then” logic into the playbook diagrams to account for multiple variables and decisions trees for the movements of each player.

In one embodiment, the environment module 308 receives or captures biometric data, and other metrics, for players on a team including a player's height, weight, speed, agility, conceptual understanding, pulse, muscle reflex metrics, and/or the like to inform or guide the movements of the dynamic playbook diagrams within a 3D/VR environment. In one embodiment, the environment module 308 tracks and captures biometric data directly from a user's GPS-enabled device as the user participates in a sport.

In one embodiment, the environment module 308 allows users to input playbooks, biometric data, quiz data (such as code words and team terminology), and team branding for opponent teams to create simulated (pre-game) learning experiences. In such an embodiment, the environment module 308 may generate scouting reports based on the simulated learning experiences.

In one embodiment, the environment module 308 takes learning experiences and automatically generates 3D video-game-like experiences on smartphones, tablets, headsets, and computers. These experiences incorporate dynamic playbooks, biometric data, GPS data, team branding, scouting reports, and/or the like for highly realistic experiences. Users learn their team's content and opponent's content through simulations such as simulated math-ups that pit two teams against each other to get a sense of what interactions will be like between specific teams or players.

In such an embodiment, users can customize the viewing location, angle, speed, and time of player motion to provide an on-field experience. For example, a soccer goalie can view a penalty kick from the eyes of the goalie, or a football linebacker can view the opposing offensive snap as if he is standing next to the linebackers on his team. As a further example, users can also view the experience from birds-eye, the press box, the end zone, or goal, or the sideline. Users have full customizability of viewing from anywhere within a half-dome 3D space above or on the field.

In one embodiment, 3D and VR playbooks include “watching” the player movement take place, but also controlling the players, as in a video game. Users can move players and make decisions (such as passing the ball) during the play and learning experiences may be built off of this functionality.

Within the 3D/VR environment, the gamification module 204 may present the following games, for example:
a. Quarterback read: View a defense from within the quarterback's helmet to identify what defensive formation or scheme they are using. This is a speed recognition game and can be transferred to other players on the offense and defense.
b. Run my route: Football skill players move their avatar along the correct route for a specified play. If they move too far outside of the correct route, or too slowly, they lose points.
c. Stop the blitz: Offensive line players identify a blitz as it is happening and move their player in the correct direction to stop it.
d. Find the hole: Soccer players identify where the hole/available space is on the field based on the spacing of the current players.
e. What next: Basketball players see the original play or set that was initiated, and then see how the defense is responding, and indicate the appropriate response movement from their team.

In one embodiment, the environment module 308 allows the creation of games that simulate the muscle training previously done on the field. For instance, kinesthetic learners can train muscle reactions with even small physical movements, measurable by smartphones, or other devices. For example, the “Pass Priority” game will show a quarterback the movement of a play and the quarterback must determine if the first priority pass receiver is on the right side or left side of the field. The quarterback then tilts his phone in the direction of the receiver. This is a speed game to recognize as many “quarterback reads” as possible in 60 seconds.

In further embodiments, users can accomplish thousands of repetitions of recognizing what is taking place in a game through simulation. For instance, movement within a game may be displayed, and the user's job is to tap on players or parts of the field according to various instructions. For example, a soccer player can identify the ideal location to pass the ball, based on field movement. The faster the user identifies this, the higher their points in the simulation.

In one embodiment, the environment module 308 may provide hyper-experiential VR functionality, which may be applicable to most if not all of the features listed above to provide an even higher level of simulation by using VR goggles and controllers, as well as haptic suits and GPS data. Players will experience all features noted above in a meta-world learning environment.

In one embodiment, certain kinesthetic reaction games are possible within the 3D/VR environment such as passing a ball, catching the ball, moving their feet, rotating their bodies, ducking, jumping, blocking, and/or the like.

In one embodiment, the environment module 308 may present augmented reality elements/experiences to facilitate deeper learning while playing sports in real life. These experiences may include using glasses or goggles that recognize the environment and cue players with instructions (such as a line to follow to run their route), cues (such as information about a player), biometrics (such as speed), and/or the like.

The simulation module 310, in one embodiment, is configured to simulate player attributes and characteristics including movements, speed, agility, quickness, strength, and/or the like based on real-life measurements of the players, e.g., combine data, performance data, workout data, and/or the like, e.g., within the 3D/VR environment. In certain embodiments, the simulation module 310 creates a model of each player, e.g., using an XML, framework, a database, and/or the like, that describes the user's attributes and characteristics, physical abilities, physical measurements, and/or the like that can be used to simulate how a play will move on a field, court, rink, or the like, including conditionality and steps.

The simulation module 310 may use the simulation data to run simulations, using artificial intelligence/machine learning algorithms, to identify potential statistical mismatches, audibles, high-yield plays, plays with the highest probability of success, and/or the like, against different defenses/opponents/formations, and/or the like. In certain embodiments, a “sports IQ” or other ranking, score, value, or the like may be calculated, determined, or the like to a player based on the player's attributes and characteristics.

In one embodiment, the mentoring module 312 is configured to facilitate two-directional communication and feedback directly between players/learners/users and coaches/mentors. In such an embodiment, the mentoring module 312 may provide tools for sharing media and data, for facilitating chat, messaging, audio, or video conferencing, and/or the like between the players/learners/users and the coaches/mentors. In one embodiment, the mentoring module 312 may present a list of mentors that are available or who have otherwise signed up to be a mentor, which the user can select from to connect directly with the mentor. The mentor list may be refined based on the sport, the type of lessons being learned, the game film being presented, the player position, and/or the like.

In one embodiment, the personality module 314 is configured to present personality assessments for a user to complete, the results of which may be used to customize the learning games. In one embodiment, the personality module 314 may present personality assessments throughout the user's experience with the learning games to continue to refine the learning games based on the user's personality traits.

In one embodiment, using data from the personality assessments, the personality module 314 generates customized trainings/learning games for individuals, groups, teams, and/or the like customized to the unique personality set of the members in the group. For example, an “H” personality and a “K” personality may do well together within a certain set of guidelines but may struggle if those guidelines are not followed.

In one embodiment, the personality module 314 may provide, periodically, mental health assessments, check-ins, or the like. In such an embodiment, the results of the mental health assessments may be analyzed and used to determine a mental state or health of a user and alert, notify, or the like mental health professionals, when needed (and within federal, state, or other government regulations).

In one embodiment, the engagement module 316 allows users to subscribe to content offered by experts and influencers in a discipline. Content creators/experts can create learning experiences, charge a price for entry, and interact with learners in their community.

In one embodiment, users, both content creators and learners, can create competitive leagues to measure learning or accomplishment. These leagues facilitate up-to-date sports data for a fantasy sports-style competition of mastery.

In one embodiment, the engagement module 316 facilitates a variety of prize opportunities for users. One example of a prize is mentoring/1-on-1 time with local and international sports heroes. Users can use points to purchase an amount of time, e.g., a 5-minute mentoring session with volunteer sports heroes. These sports heroes log in and are presented with a brief bulleted list of material about which to congratulate or encourage the user and questions to ask the user. The two may be connected for a video chat, which automatically disconnects after the allotted time.

In one embodiment, the engagement module 316 provides live, real-time interaction with college and professional broadcast games, e.g., via an application executing on a mobile device. The live, real-time interaction may include voice interaction, text interaction, social media interaction, and/or the like. In various embodiments, the engagement module 316 provides fantasy leagues that allow fans to compete against each other using professional and/or college virtual reality content that athletes would use for training. In such an embodiment, the engagement module 316 calculates odds of success and odds of victory based on real-time developments various metrics, as well as allowing “fantasy” fans to test their play calling abilities in real-time against coaches in the actual game based on algorithms (e.g., machine learning) and metrics.

In one embodiment, the lesson module 318 is configured to generate a lesson related to a sport, e.g., a lesson about the sport in general, about a particular position, about the sport rules, and/or the like. The lesson module 318 may incorporate content that has been uploaded, e.g., digital playbook information, slides, videos, images, audio, and/or the like, and/or incorporate information from online sources (e.g., Wikipedia®) to generate a lesson for a user.

In one embodiment, the lesson module 318 provides an interface for creating a lesson. The interface may allow a user to incorporate multimedia content, learning games, and/or the like into the lesson. For example, the user may create a lesson that teaches the rules of basketball by using text to explain the rule, a video to show how the rule is enforced, and a quiz to test the user's knowledge of the rule.

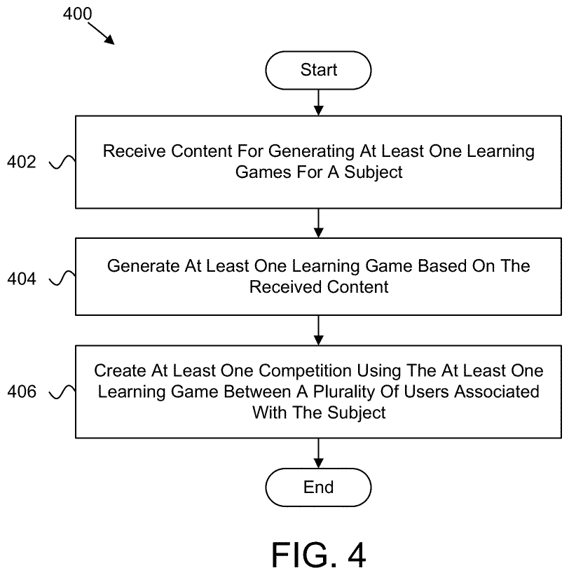

FIG. 4 depicts one embodiment of a schematic flow chart diagram for one embodiment of a method 400 for interactive learning. In one embodiment, the method 400 begins and generates 402 a digital playbook comprising a plurality of plays for a sporting team. In further embodiments, the method 400 generates 404 at least one learning game based on the digital playbook. In some embodiments, the method 400 creates 406 at least one competition using the at least one learning game between a plurality of members of the sporting team, and the method 400 ends.

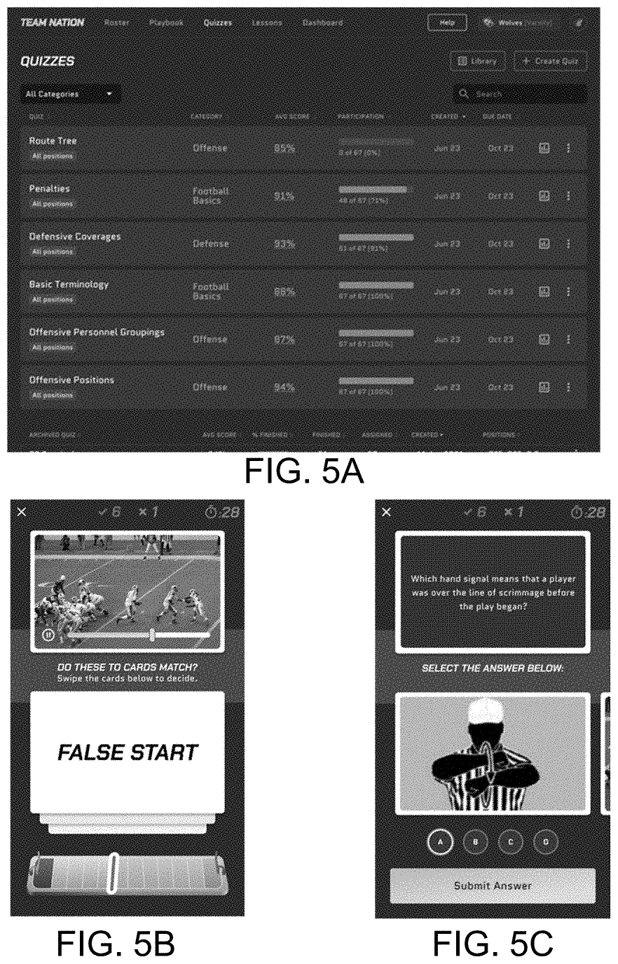

FIGS. 5A-5C depict embodiments of a quiz interface. In an example embodiment, users (such as coaches) can upload/create content to be published as quizzes to players within their team. Users may specify which players have access to these quizzes and edit them after publishing them. The quizzes may fall into one of two categories: automatically generated or hand built.

Quizzes generated automatically may require users to input a term and corresponding content. The result is a mix of correct and incorrect answers shown to players on cards which they must swipe left or right to match to a card at the top of the screen. Hand built quizzes may require a user to write out a question and specify correct and incorrect answers. The result is a question with answers below, and a player chooses which of the answer is correct. The performance of the player is recorded and displayed in the information dashboards and menus, which are visible to both coaches and players. Users are also able to view a preview of quizzes they build as they are building them.

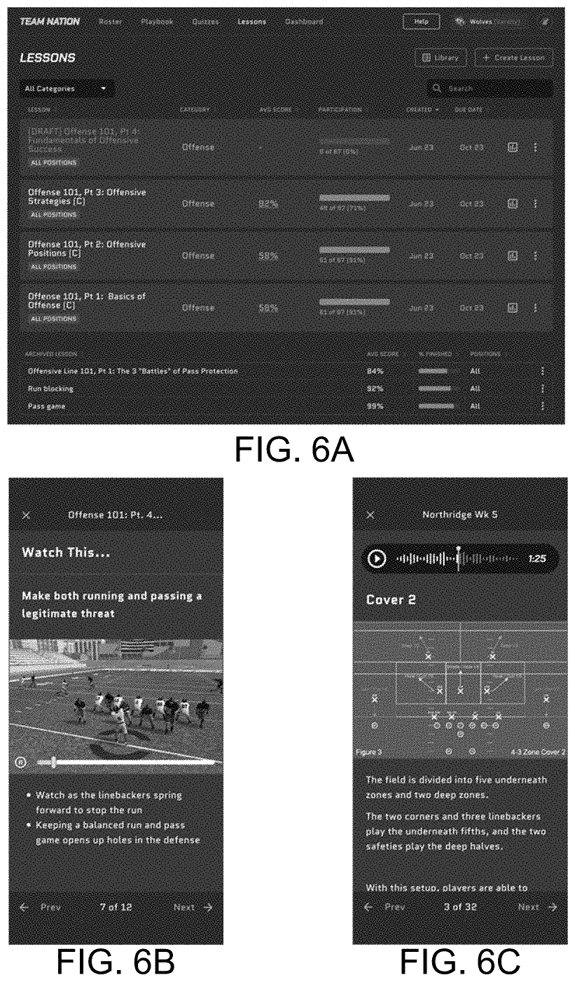

FIGS. 6A-6C depict embodiments of a lesson interface. In one embodiment, users can upload/create content to be published as lessons to players within their team. Users can specify which players have access to these lessons and edit them after publishing them. Lessons appear to players as slides with text, images, and/or videos. Users can also record narration for each slide, which will play for players. Players watch videos or listen to audio narration on a slide before they can proceed to the next one. A user can also embed quizzes (from the quiz feature) into lessons, which players take before they can proceed. Alternatively, a user can create multiple-choice questions within the lesson for a player to answer. Performance data for players is recorded and displayed in the information dashboards and menus, which are visible to both players and coaches. Users can also set due dates for the lessons they create. Users are also able to view a preview of lessons they build as they are building them.

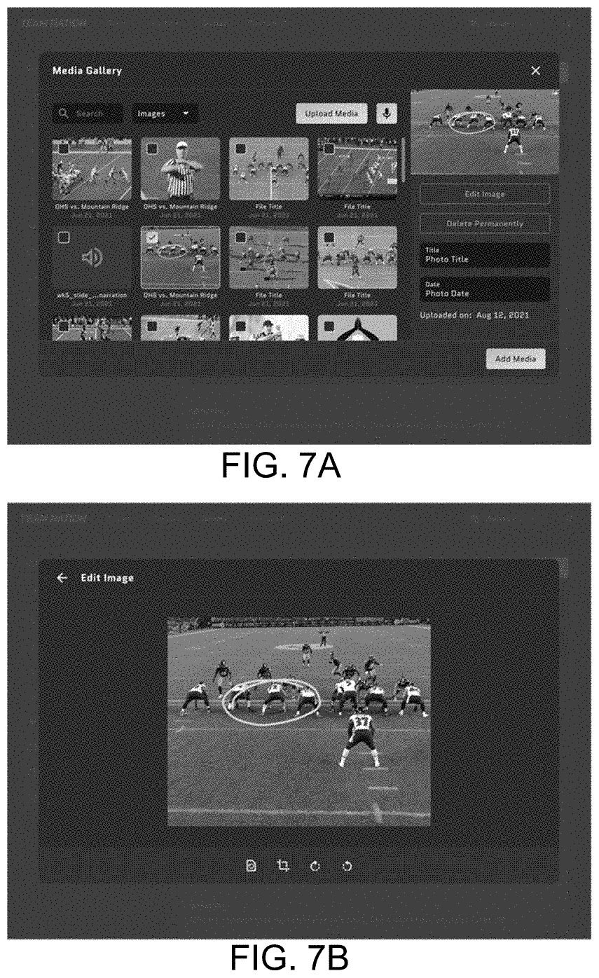

FIGS. 7A-7B depict interfaces for a media gallery and content annotation, respectively. In one embodiment, users can upload media (e.g., photos, videos, audio) to be stored. Users can access this media and use it as content for quizzes and lessons. Users can also edit metadata for the media. For images and videos users can edit various properties of the media and save those edits. For example, users can crop, rotate, and/or draw on images.

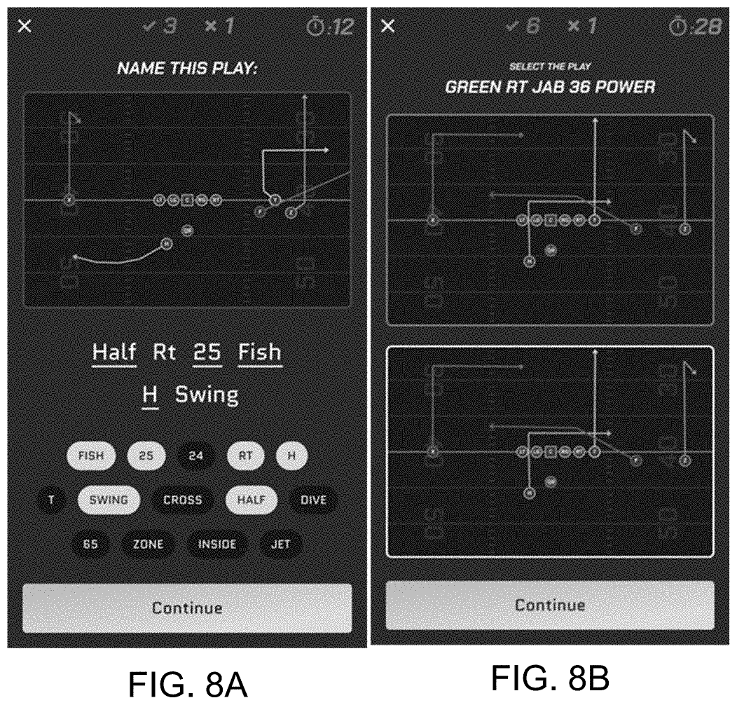

FIGS. 8A-8B depicts two examples of learning games automatically generated from a team playbook. The first, shown in FIG. 8A, presents a player with an image of a play and some of the words in that play's name, with blank spaces in place of the rest of them. A group of words is also presented, and a player chooses from the group how to fill in the blank spaces in the name of the play. The second, shown in FIG. 8B, shows the name of a play and two play cards to a player, who chooses which of the two cards matches the name provided.

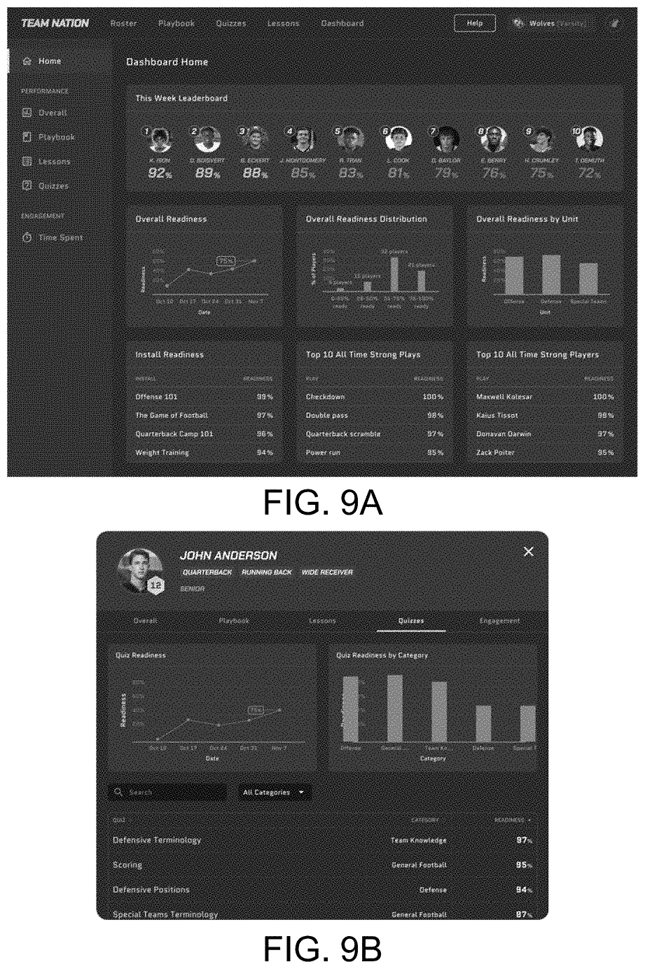

FIGS. 9A-9B show interfaces for an information dashboard. In one embodiment, data for player performance on playbook games, quizzes, and lessons is recorded and displayed for coaches and players to view. Various charts and graphs may be generated and presented to help visualize trends and outliers, as well as areas where a player or the team needs to improve. Players and coaches also have access to a full leaderboard of all the players on a team. Users can access specific performance data for individual players, plays, quizzes, or lessons. Users may also be able to see how much time players have spent on learning games, reviewing the playbook, reviewing film, and/or the like.

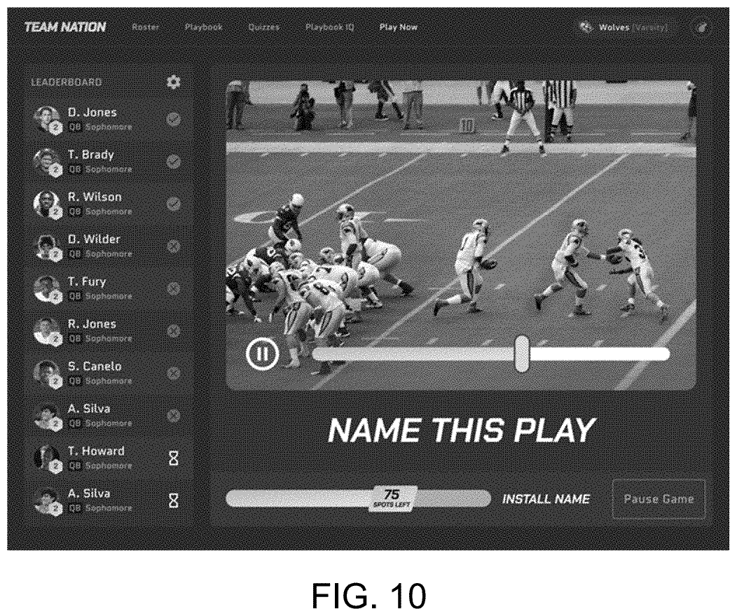

FIG. 10 shows an interface for a multiplayer game. In one embodiment, players compete directly against each other in quizzes and games. Other players can spectate those games and interact with competing players. Additionally, a user will be able to start a team-wide game, where questions are displayed on a large screen/computer and players use their mobile devices to interact with those questions, competing in real-time against the rest of the team. Data for these games will be available to both coaches and players in the information dashboard.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a content module that receives content for generating at least one learning games for a subject;
a gamification module that generates the at least one learning game based on the received content; and
a competition module that creates at least one competition using the at least one learning game between a plurality of users associated with the subject.

2. The apparatus of claim 1, further comprising a playbook module that generates a digital playbook comprising a plurality of plays for a sporting team, the received content comprising the plurality of plays.

3. The apparatus of claim 2, wherein the playbook module presents an interface for generating a play for the digital playbook.

4. The apparatus of claim 2, wherein the playbook module presents one or more predesigned plays that can be selected to add to the digital playbook.

5. The apparatus of claim 2, wherein the at least one learning game comprises questions related to at least one play within the digital playbook.

6. The apparatus of claim 2, further comprising a multimedia module that receives and integrates multimedia content into at least one of the digital playbook and the at least one learning game.

7. The apparatus of claim 6, further comprising an integration module that communicates with at least one third-party application for receiving at least one of the digital playbook and the multimedia content.

8. The apparatus of claim 7, wherein the playbook module generates metadata tags for the multimedia content based on one or more identifiable characteristics of the multimedia content, the metadata tags used to generate the at least one learning game.

9. The apparatus of claim 1, further comprising a dashboard module that provides an interface for visualizing statistics generated as a result of the at least one competition.

10. The apparatus of claim 1, wherein the at least one competition comprises a real-time competition between the plurality of users.

11. The apparatus of claim 1, further comprising an environment module that renders the at least one learning game in one of a virtual reality and augmented reality environment.

12. The apparatus of claim 1, wherein the received content comprises a plurality of flash cards associated with the subject.

13. A method, comprising:
receiving, by a processor, content for generating at least one learning games for a subject;
generating at least one learning game based on the received content; and
creating at least one competition using the at least one learning game between a plurality of users associated with the subject.

14. The method of claim 13, further comprising generating a digital playbook comprising a plurality of plays for a sporting team, the received content comprising the plurality of plays.

15. The method of claim 14, further comprising presenting an interface for generating a play for the digital playbook.

16. The method of claim 14, further comprising presenting one or more predesigned plays that can be selected to add to the digital playbook.

17. The method of claim 13, further comprising providing an interface for visualizing statistics generated as a result of the at least one competition.

18. The method of claim 13, further comprising rendering the at least one learning game in one of a virtual reality and augmented reality environment.

19. The method of claim 13, wherein the received content comprises a plurality of flash cards associated with the subject.

20. An apparatus, comprising:
means for receiving content for generating at least one learning games for a subject;
means for generating at least one learning game based on the received content; and
means for creating at least one competition using the at least one learning game between a plurality of users associated with the subject.
